(19) United States
(12) Patent Application Publication
(10) Pub. No.: US 2011/0286490 A1
(43) Pub. Date: Nov. 24, 2011

(54) Method of Producing Activated Carbon Material

(76) Inventors: John Abrahamson, Christchurch (NZ); Rahul Shastry, Christchurch (NZ)

(21) Appl. No.: 13/131,383

(22) PCT Filed: Nov. 30, 2009
(86) PCT No.: PCT/NZ2009/000271

§ 371 Date: Aug. 10, 2011

(30) Foreign Application Priority Data
Nov. 28, 2008 (NZ) 573247

(51) Int. Cl. H05B 7/18

(52) U.S. Cl. 373/60

(57) ABSTRACT

A method for producing an activated carbon material, such as a tape or belt of carbon fibres, includes within a reaction chamber causing relative movement between a carbon-containing substrate and an electric arc in a gap between two electrodes or adjacent an electrode so that an electric arc exists between the electrode and the substrate to heat the substrate to a substrate surface temperature effective to activate the carbon-containing substrate and above about 3750K. The activated material has high adsorbency, and increased capacitance and conductivity.

### FIELD OF INVENTION

The invention relates to a method for producing activated carbon material, suitable for use as an electrode in electrochemical cells and supercapacitors, or as an adsorbent of for example volatile organic compounds (VOCs).

### BACKGROUND

Carbon materials such as carbon fibre materials may be activated to create pores in and thus increase the surface area of the material, making the materials useful for various applications including as electrodes in cells and supercapacitors and as adsorbents, by “physical activation” with steam or carbon dioxide at temperatures around 1000K or by “chemical activation” by for example aqueous alkali solutions.

In the arc-discharge method for producing carbon nanotubes such as described in our international patent application WO 03/082733, current flows between carbon electrodes creating an arc between them. Evaporation of the carbon electrodes forms a vapour-cluster-nanoparticle suspension which condenses as nanoscale carbon fibrils or nanotubes.

### SUMMARY OF INVENTION

In broad terms the invention in one aspect comprises a method for producing an activated material, including moving a carbon-containing substrate within a reaction chamber either through an electric arc in a gap between two electrodes or past an electrode so that an electric arc exists between the electrode and the substrate at a temperature and time effective to activate the carbon-containing substrate substantially without causing nanotubes to form on the substrate.

In broad terms in another aspect the invention comprises a method for producing an activated carbon material, including moving a carbon-containing substrate within a reaction chamber either through an electric arc in a gap between two electrodes or adjacent an electrode so that an electric arc exists between the electrode and the substrate to heat the substrate to a substrate surface temperature effective to activate the carbon-containing substrate and above about 3750K.

In broad terms the invention in a further aspect comprises a method for producing an activated carbon material, including moving a carbon-containing substrate within a reaction chamber either through an electric arc in a gap between two electrodes or past an electrode so that an electric arc exists between the electrode and the substrate to activate the substrate, the arc having a sufficient voltage and/or current ripple to activate the substrate substantially without causing nanotubes to form on the substrate.

In broad terms in another aspect the invention comprises a method for producing an activated carbon material within a reaction chamber, including causing relative movement between a carbon-containing substrate and an electric arc in a gap between two electrodes or past an electrode so that an electric arc exists between the electrode and the substrate to activate the substrate at a speed such that the substrate has a residence time in the arc of less than three seconds and/or at a speed of more than 3 mm per second.

By “activation” is meant the creation of pores typically of nanoscale and typically up to 50 nm in diameter, and typically also coarser corridor pores up to 100 nm in diameter in the material, or on the surface of the material, by the arc treatment, and by vaporising or removing in the arc some matter of the carbon substrate and preferably non-graphitic carbon or a sufficient part or a major part of the non-graphitic carbon of the substrate. The interior pores can be termed “internal activation” to distinguish from the surface generated by exterior nanostructures which may be deposited by the arc (e.g. nanotubes).

Either an arc may be formed between two electrodes and the substrate moved through the arc or alternatively the arc may exist between one electrode and the substrate, which is most conveniently earthed. Another electrode may be used to initiate the arc, and may then be withdrawn leaving an arc between one electrode and the earthed substrate.

Typically one or both electrodes will be carbon electrodes such as graphite electrodes, but it may be possible that the electrodes or electrode are formed of a non-carbon material (of sufficient refractory nature that it does not generate impurities at the reactor temperatures) and that only the substrate itself is carbon.

The substrate may be moved at a substantially steady speed through the arc or in steps.

The substrate may be composed of carbon fibres and may comprise a tape or belt woven from carbon fibres or a paper of carbon fibres for example. Preferred substrate materials include carbon fabric derived from rayon, polyacrylonitrile, phenol resin, and pitch materials.

Preferably the substrate is moved at a speed such that the substrate has a residence time in the arc of less than three seconds. Preferably the substrate is moved at a speed of greater than 3 mm per second.

Preferably the method includes flushing an inert gas through the reaction chamber, or an otherwise inert gas which contains a low amount of oxygen sufficient to react with other species such as carbon species without destructively oxidising the substrate on cool down. Most preferably a flow of gas is directed to cool one or both of the electrodes and/or the substrate, and particularly to cool the substrate after it has passed through the arc. Alternative to the gas containing a low concentration of oxygen, the substrate after exiting the reactor chamber may be moved through an oxygen-containing gas in a separate lower temperature heating stage e.g. a resistive heating stage, to separately provide a further micropore activation. The arc activation gives larger pores (without the <2 nm pores) than does activation with an oxygen-containing gas, and for many uses the arc activation is optimal, but a further activation to provide 2 nm pores can be desirable.

It is believed that the arc discharge takes place by an electron and ion flow between both electrodes and/or between one electrode and the substrate. Free electrons and ions are accelerated by the voltage difference between the electrodes. The electrons collide with gas atoms, leading to excitation of the atoms and causing emission of radiation. Atoms and molecules are ionised via collisions involving the electrons. Mainly N⁺, N₂⁺, Cₙ⁺ and Cₙ⁻ ions occur in the arc when the discharge is performed in nitrogen. The collisions raise the arc temperature. Non-graphitic carbon of the substrate vaporizes leaving graphitic carbon so that nanoscale pores are formed in the substrate (by the loss of (mostly) non-graphitic carbon), activating the substrate.

It has been found that activated carbon material produced by the method of the invention may have high quickly accessible adsorbency in the gas phase, to for example VOCs, and high surface capacitance, useful for porous electrodes in cells. Also abnormally large pores of size distribution in the range 2 to 10 nm and larger may be developed. This hierarchy of pores allows reactants and ions to diffuse easily and quickly to the pore surface even in the centre of fibres of the material from the outer surface of the carbon fibres (e.g. over a distance of around 5 micron).

The activated carbon material produced by the method of the invention may have increased electrical conductivity relative to the material before activation, and after activation may be a good conductor (similar to polycrystalline graphite).

In broad terms in a further aspect the invention comprises a supercapacitor or battery or fuel cell comprising one or more high surface area electrodes comprising an activated carbon material produced by the method(s) defined above and described herein.

By “supercapacitor” is meant a capacitive energy storage device housing capacitance of at least 1 Farad.

Temperature values given in this specification refer to blackbody temperature values measured by observing the arc-facing surface of the substrate with an optical pyrometer.

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

### BRIEF DESCRIPTION OF THE FIGURES

The invention is further described with reference to the accompanying figures by way of example wherein:

FIG. 1 schematically illustrates one form of reactor for the continuous or semi-continuous activation of a carbon substrate according to the invention, and

FIG. 2 is a close up schematic view of the electrodes and the substrate path between the electrodes of the reactor of FIG. 1,

FIG. 3 is a photo micrograph of the woven carbon fibre tape used as the substrate in run 1 and 2 for the work described in the subsequent examples,

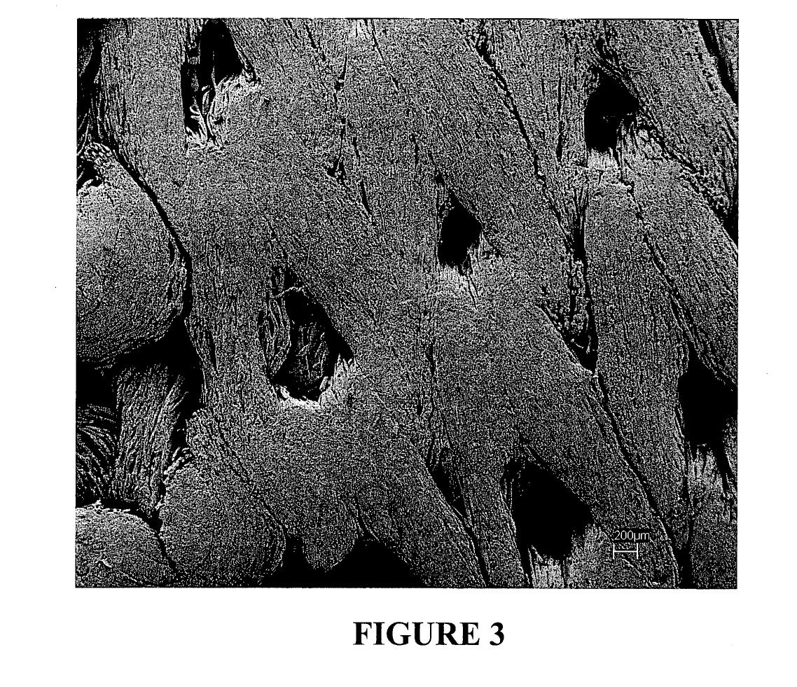

FIG. 4 is an SEM image of the Rayon based woven carbon fibre tape UVIS TR-3/2-22 manufactured by Carbonics GmbH, Germany showing activation of carbon fibres after run 1,

FIG. 5 is an SEM image of the PAN based woven carbon fibre tape CW1001 manufactured by TaiCarbon, Taiwan sold under the brand name KoTHmex showing activation of carbon fibres after run 2,

FIG. 6 is an enlarged SEM image of PAN based woven carbon fibre tape CW1001 depicting interior activation of individual fibres on the carbon tape. (Please note that the Rayon based woven carbon tape reveals similar morphologies at higher magnification and therefore not shown), and

FIG. 7 is a graph of observed temperature of the carbon substrate during arc attachment, for varying substrate-cathode arc gaps, for two cathode diameters and two arc currents, referred to in the subsequent description of experimental work.

### DETAILED DESCRIPTION

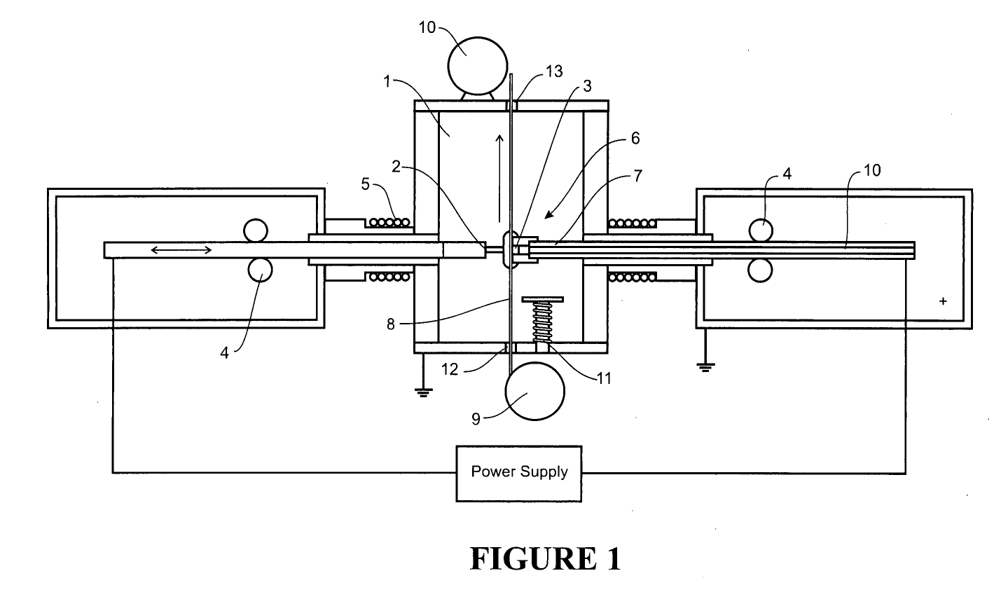

In FIG. 1, reference numeral 1 indicates a reactor chamber in which the discharge arc is created, which may have walls formed of brass or stainless steel or similar. Electrodes 2 and 3 project into the reactor chamber 1 and typically one or both are mounted by motor driven electrode-feeding mechanisms 4 as are known in the art, so that the position of electrode 3, which maybe the anode, and electrode 2, which may be the cathode (the positions of the anode and cathode may be reversed), may be adjusted to create the arc, and in operation to maintain or if required adjust the arc. Each electrode enters the reaction chamber through an insulating collar through an aperture in the reaction chamber wall, in the embodiment shown. Typically the reactor will have one or more viewing ports sealed off with plate glass in the side wall of the reactor enabling an operator or control sensor to monitor the arc and electrode positions, and if necessary to view surfaces with a pyrometer (through quartz plate). The reactor chamber 1 preferably includes a surrounding water jacket (not shown) through which water is circulated to cool the walls of the reactor chamber during operation, or other suitable cooling system. Water under pressure may be admitted through an inlet to the water jacket with the water flow being controlled by valve, and exits from outlet. A cooling system 5 consisting of copper tube coils wound around each electrodes through which water is circulated may also be arranged to cool the electrode(s).

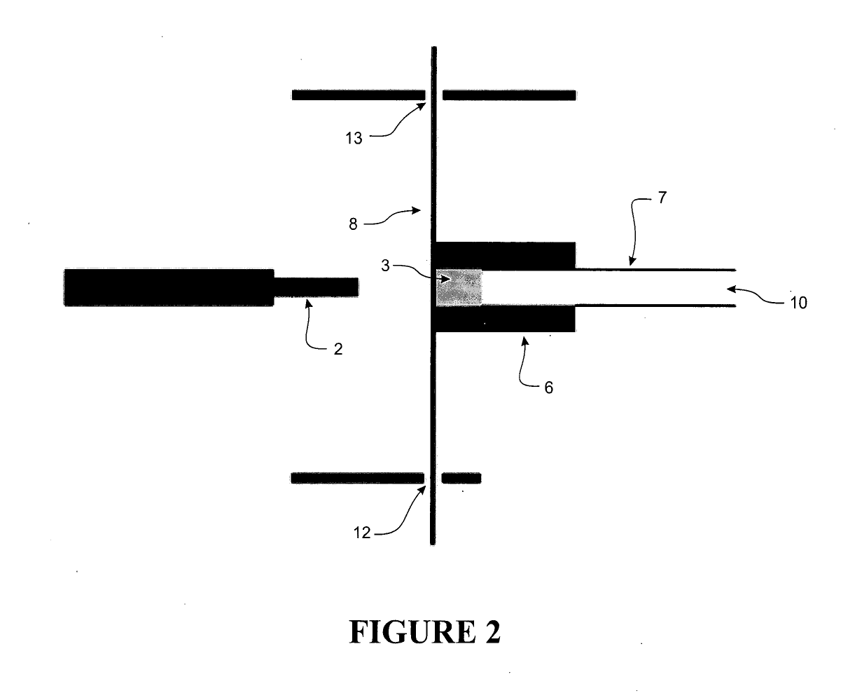

Carbon-substrate 8 passes between electrodes 2 and 3 and through the arc during operation of the reactor, as shown. This is shown in more detail in FIG. 2. The substrate may enter the reactor chamber through a slit 12 in the reactor chamber and leave through a similar exit slit 13 in the reactor chamber on the other side of the electrodes. A mechanism is provided to feed the substrate (which is typically a high purity flat carbon tape or belt or similar) through the reactor chamber, and may be of any suitable form. For example during operation of the reactor the substrate may be unwound from a spool 9 driven by a gearbox which is coupled to an electric motor with an appropriate control system. This is arranged to operate the motor to unwind the substrate at a slow constant speed during a production run, or which enables an operator to vary the speed at which the substrate is unwound with an appropriate, control system. In another arrangement the substrate unwind system may be arranged to move the substrate through the arc in steps by stepping an electric motor which controls unwinding of the substrate, so that the substrate is stationary in the arc for a few seconds, before being stepped on to bring the next portion of the substrate into the arc, before being stepped on again etc. A speed which causes the substrate to move through the arc with a residence time in the arc of less than 3 seconds has been found suitable, whether the substrate is moved at a steady speed or in steps. The substrate is kept under moderate tension as it passes through the reactor, by applying a torque to the receiving spool. The direction of travel of the substrate is preferably upwards for better arc stability but can also be downwards.

During operation the interior of the reactor is preferably at or slightly above atmospheric pressure, and the gas flow exiting the reactor through slits 12 and 13 is extracted via a fume hood or similar. An inert gas such as nitrogen, argon or helium for example is flushed through the reaction chamber at a rate between 3-10 L/min, and it is preferred this is done by introducing a controlled gas flow inside the reaction chamber 1 through one of the openings 11 at the base of the reactor. Additionally or alternatively a gas flow may also be directed through the tungsten tube 7 via a porous carbon anode 3 to flush away carbon vapour and/or cool the substrate during arc treatment.

The cooling through porous carbon 3 assists in avoiding burn-through of the substrate and removal of excessive carbon vapour during arc discharge, whereas the operation of the other inlet 11 serves to control oxidation.

The anode as well as the spool which drives the tape are preferably earthed. Any take up mechanism for collecting the substrate after it has passed through the reactor chamber is also preferably earthed, as is also the reactor shell.

Referring to FIG. 2, it may be preferable for one electrode, which in the figure is the anode 3, to be positioned to impinge on the substrate 8 such that the substrate is tensioned against that electrode as the substrate moves past it as schematically shown. A gas flow 10 to cool the substrate (flow rate in the range 0-0.6 L/min) is directed through the carbon anode plug 3 housed inside a cylindrical carbon anode support 6 fixed on a tungten tube 7. This system comprises the anode of the reactor.

The substrate may be of any desired type but it is believed that best results may be achieved with a substrate composed of carbon fibres such as a tape or belt woven from carbon fibres or a paper of carbon fibres for example. Preferably the substrate and the electrodes have a high carbon purity since any impurities will vaporise or partially vaporise at the temperatures within the reactor. In particular it is desirable to avoid too high hydrocarbon impurities which can disrupt the fibres on their rapid heating. Typically the electrodes and substrate should have a carbon purity of at least 95% and preferably in excess of 99%.

In some embodiments the electrode spacing i.e. the inter-electrode gap, is less than 5 mm or above 8 mm; and may be in the range 2 to 5 or the range 8 to 12 mm.

The current density should be sufficiently low to substantially avoid structural damage to the substrate (i.e. damage which would significantly affect a graphitic part of and thus the structural integrity of the substrate) but sufficient to achieve a current density at the contact point of the arc on the substrate (and the arc tends to spread at the contact point on the substrate) which is sufficient to vaporise a major fraction of non-graphitic carbon (but no more than a minor fraction graphitic carbon) and activate the substrate. In some embodiments the arc current is below or above 16 Amps, more preferably is in the range from above 16 Amps to about 20 Amps or from about 10 Amps to below 16 Amps. In some embodiments the current density is above 1 Amps/mm² for example. It is an advantage of the method of the invention that the arc tends to spread over the substrate, which is advantageous for activating as broad an area of the substrate as possible in a non-destructive manner. A transition to a highly destructive arc mode occurs above a certain current, which may be 16 A or 20 A, depending on the substrate.

It is preferred that gas flushed through the reactor chamber contains sufficient oxygen to react with other carbon species present without oxidising the carbon fibres destructively on cool down. Oxygen concentrations of about 800 and 6000 ppm have been found effective.

The method may be carried out in the presence of an introduced catalyst. Suitable catalysts may be metal catalysts such as Ni—Co, Co—Y, Ni—Y catalysts or alternatively lower cost metal catalysts such as Fe or B catalysts for example.

In some embodiments the arc has a sufficient voltage and/or current ripple to activate the substrate substantially without causing nanotubes to form on the substrate. Preferably the power supply should have a peak to peak ripple of more than one volt and/or more than 0.5 Amps. It has been found that nanotubes may form with lower levels of ripple. In these embodiments where the power supply has sufficient ripple to activate the substrate without causing nanotubes to form on the substrate, the arc may be operated to generate any substrate surface temperature effective to activate the carbon-containing substrate, and typically at any temperature above about 3600K. The temperature range also is constricted by achievement of stable arc operation.

In some embodiments moving the substrate (or the arc) at a speed of more than 3 mm per second and/or such that the substrate has a residence time in the arc of less than three seconds has been found to activate the substrate without causing nanotubes to form on the substrate at any substrate surface temperature, and typically at any temperature above about 3600K.

As stated it has been found that activated carbon material produced by the method of the invention has high rapid absorbency to for example VOCs. Also pores of size distribution in the range 2 to 10 nm or larger may be developed. This allows reactants and ions to diffuse easily and quickly to the pore surface even in the centre of fibres of the material from the outer surface of the carbon fibres (e.g. over around 5 micron). Optionally the arc-activated material may subsequently be given a short CO₂ or H₂O activation to etch further short pores for example of less than 2 nm off the corridor pores produced by the arc activation.

In an alternative the single electrodes 2 and 3 may each be replaced by a number of adjacent anodes and cathodes to generate multiple arcs adjacent to each other for processing a wider substrate.

The invention is further illustrated by the following description of experimental work which is given by way of example and without intending to be limiting.

### EXAMPLE 1

A Rayon-based woven carbon fibre tape UVIS TR-3/2-22 manufactured by Carbonics GmbH, Germany was used as a substrate for Run 1. The tape was a cross weave knitted fabric, the specific weight of the tape was 470 g/m², its thickness was 1 mm with an average filament diameter of 8-10 μm, and it had a carbon content of 99.9%. The tape was cut into strips of width 25 mm.

A PAN based woven carbon fibre tape CW1001 manufactured by TaiCarbon, Taiwan sold under the brand name KoTHmex was used as a substrate for run 2. The tape was a woven fabric, the specific weight of the tape was 300 g/m², its thickness was 0.7 mm with an average filament diameter of 6-7 μm, and it had a carbon content of 99.98%. The tape was cut into strips of width 25 mm.

The tape strips were fed into a reactor similar to that described with reference to FIGS. 1 and 2 through a slit 12 from a spool 9, into the reaction chamber 1. The tape exited the reactor through an outlet slit 13. The electrodes were graphite electrodes of 7.66 mm in diameter (anode) and 7.66 mm diameter (cathode) for run 1. The electrodes were graphite electrodes of 7.66 mm in diameter (anode) and 3 mm diameter (cathode) for run 2. The electrode position was set while the reactor was open during setup. When setting the zero for the electrode position the cathode (aligned horizontally) was moved forward until it contacted and pushed against the tape. The distance between the electrode tips was set to about 10-12 mm for run 1 and about 5-6 mm for run 2.

During operation the reactor was flushed with nitrogen or a nitrogen-air mixture at a rate set to 10 L/min, and cooling water was circulated through cooling coils around the electrode supports. To strike the arc, the cathode was moved forward until the discharge took place, then the cathode was withdrawn slightly to establish the arc. The current was set to approximately 20 A for run 1 and 16 A for run 2. The tape was fed through in one run at a speed of 3 mm/second for run 1 and 4 mm/second for run 2.

An additional cooling gas was introduced through a porous carbon anode 3 to cool the tape close to the arc attachment zone (as shown in FIG. 1). After the desired length of the carbon tape had been run through the reactor the discharge was stopped by shutting off the power supply. Gas was flushed through the reactor for a further five minutes to remove exhaust gases.

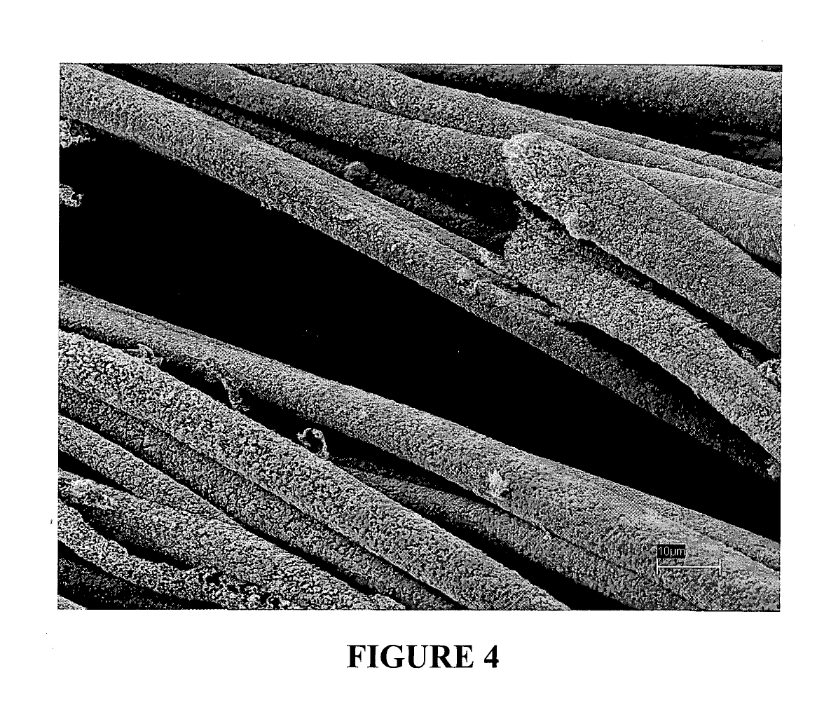

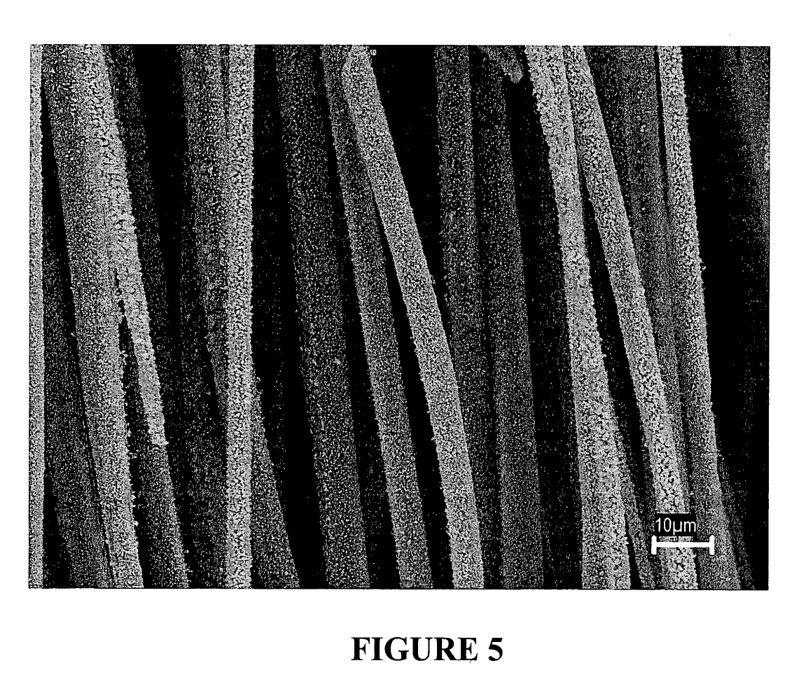

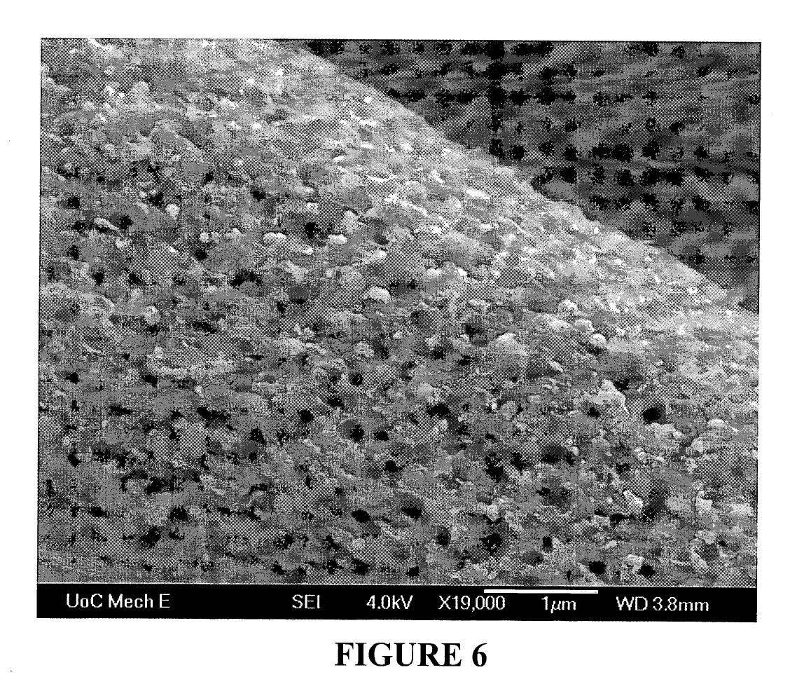

The tape samples were examined with a LEO Leica scanning electron microscope. The substrate was activated with the creation of nanoscale pores (by the loss of mostly non-graphitic carbon), on the tape for both runs. FIG. 4 is an SEM image of a portion of the tape (made from Rayon material) from run 1 and FIG. 5 is an SEM image of a portion of the tape (made from PAN material) from run 2. The morphology of pores on the individual fibres of the tapes was similar from both the runs and is shown in a much higher magnification in FIG. 6 which shows many “corridor” pores of the order 100 nm in diameter, providing rapid access for diffusion of species into the pore structure. These are the largest of the hierarchy of pores providing rapid access for species into the fabric fibres. The arc activated PAN fabric of run 2 was adsorption tested at 5 ppm each of benzene, toluene and xylene in air, and it was found by measuring desorption amounts with a gas chromatograph that 3.5×10⁻⁶ mol/g benzene adsorbed. The BET measurement of the arc activated PAN material is close to 100 m²/g.

The arc treated tapes were also found to have increased electrical conductivity significantly (despite losing some carbon). For example, an 0.5 mm thick PAN-derived carbon tape also processed as described above was found to have increased conductivity by about 30 times, with the sheet resistance dropping from around 8.5 Ohm per square as supplied to 0.3 Ohm per square.

The arc activated PAN derived substrate of run 2 was also found to have increased capacitance by around 15 times compared to the activated rayon tape of run 1. Electrochemical experiments indicated a specific capacitance of 165 F/g or 2.5 F/cm². These experiments were performed in an aqueous electrolyte (5 M KOH) and with untreated carbon fibre as the counter electrode and a pseudo Ag/AgCl reference electrode.

### EXAMPLE 2

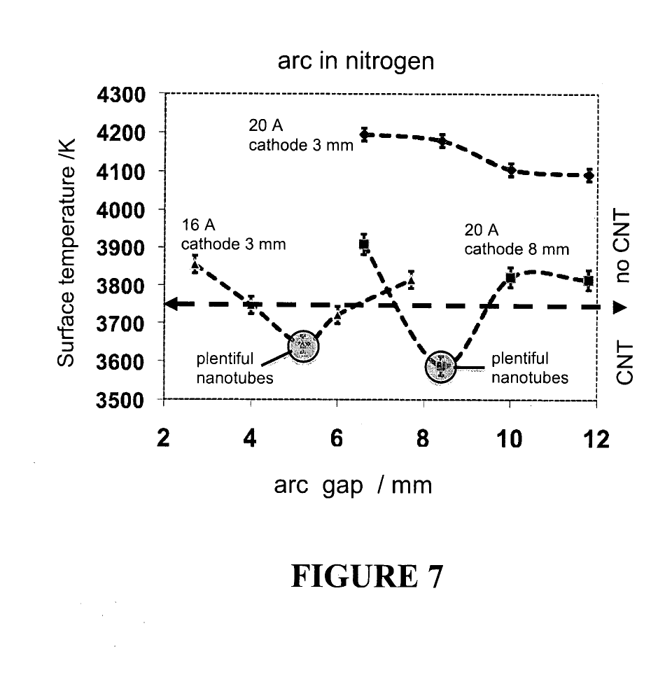

A series of runs were conducted passing a Rayon-based carbon fibre tape as described in example 1 through the arc reactor similar to-that described with reference to FIGS. 1 and 2, with changes of both cathode diameter and arc gap between runs. The temperature of the tape surface facing the arc (the arc attachment surface) was measured, with the occurrence of the carbon nanotubes noted on FIG. 7. The temperature was measured with an optical pyrometer (Optik, Germany) which filtered out a narrow band of the red light from the surface. An even narrower Ealing ElectroOptics “window filter” allowing just 10 nm of wavelength red light through (centred on a wavelength of 670 nm) was placed in line with the viewed light. This extended the temperature that the pyrometer could measure. The pyrometer was used by rotating a variable neutral density filter so that the intensity of the surface image could be seen to be equal to a reference intensity. The intensities found by this arrangement were calibrated using a standard reference carbon arc at 3800 K. The observed surface was assumed to be a black-body radiator, and Planck's law was used to calculate the temperature from the intensity at the wavelength of the red light at 670 nm.

For each combination of current and cathode diameter a 2 metre length of rayon tape was loaded onto the feed spool of the reactor, tensioned into place with contact to the anode support, and touched with the cathode to begin the arc. The cathode was withdrawn until the image projected onto an external surface showed the desired gap, and the tape fed through at a rate of 3 mm/s by setting the control on the power supply to the motor driving spool 9 in FIG. 1 for at least 200 mm before switching off the current. The procedure was immediately repeated with adjustment to the next gap value. Small samples were cut from the tape for SEM inspection.

FIG. 7 shows the measured blackbody temperature as a function of increasing arc gap between the substrate and the stand-off electrode, for ranges of electrode gaps of 3 to 8 mm and 7 to 12 mm and current values of 16A and 20A. The existence of nanotubes is also indicated. It can be seen that nanotubes formed only where the measured temperatures fell below around 3750 K, to around 3650 K. It is believed that at temperatures below about 3750 K the presence of significant numbers of nanoparticulates (probably graphene fragments) contributes to nanotube growth on the substrate.

The foregoing describes the invention including preferred forms thereof and alterations and modifications as will be obvious to one skilled in the art are intended to be incorporated in the scope thereof as defined in the accompanying claims.

1. A method for producing an activated carbon material, including within a reaction chamber causing relative movement between a carbon-containing substrate and an electric arc in a gap between two electrodes or adjacent an electrode so that an electric arc exists between the electrode and the substrate to heat the substrate to a substrate surface temperature effective to activate the carbon-containing substrate and above about 3750K.

2. A method according to claim 1 comprising moving the carbon-containing substrate through the electric arc to heat the substrate to a substrate surface temperature up to about 4200K.

3.-6. (canceled)

7. A method according to claim 1 wherein the substrate is composed of carbon fibres.

8.-22. (canceled)

23. A method according to claim 1 wherein the electrodes and the substrate have a carbon purity in excess of 95%.

24. (canceled)

25. A method for producing an activated carbon material within a reaction chamber, including causing relative movement between a carbon-containing substrate and an electric arc in a gap between two electrodes or past an electrode so that an electric arc exists between the electrode and the substrate to activate the substrate, the arc having a sufficient voltage and/or current ripple to activate the substrate substantially without causing nanotubes to form on the substrate.

26. A method according to claim 25 wherein a power supply which supplies the arc current has a rms voltage ripple of greater than 1 volt and/or current ripple of greater than 0.5 Amps.

27. A method according to claim 25 comprising moving the carbon-containing substrate through the electric arc so as to remove substantially non- graphitic carbon from the substrate.

28.-30. (canceled)

31. A method according to claim 25 wherein the substrate is composed of carbon fibres.

32.-49. (canceled)

50. A method for producing an activated carbon material within a reaction chamber, including causing relative movement between a carbon-containing substrate and an electric arc in a gap between two electrodes or past an electrode so that an electric arc exists between the electrode and the substrate to activate the substrate at a speed such that the substrate has a residence time in the arc of less than three seconds and/or at a speed of more than 3 mm per second.

51. A method according to claim 50 comprising moving the carbon-containing substrate through the electric arc so as to remove substantially non-graphitic carbon from the substrate.

52.-54. (canceled)

55. A method according to claim 50 wherein the substrate is composed of carbon fibres.

56.-57. (canceled)

58. A method according to claim 50 including tensioning the substrate against the anode (or the cathode) of the electrodes.

59. A method according to claim 50 wherein the arc current is set at a level which vaporises a major fraction of non-graphitic carbon and no more than a minor fraction graphitic carbon of the substrate.

60. A method according to claim 50 wherein the arc current is set at a level which vaporises a substantial part of non-graphitic carbon of the substrate substantially without structurally damaging a graphitic part of the substrate.

61.-63. (canceled)

64. A method according to claim 50 wherein the arc is between electrodes having an inter electrode gap of less than 5 mm or above 8 mm.

65. A method according to claim 50 wherein the arc is between electrodes having an inter electrode gap in the range 2 to 5 mm.

66. A method according to claim 50 wherein the arc is between electrodes having an inter electrode gap in the range 8 to 12 mm.

67. A method according to claim 50 including flushing a gas through the reaction chamber which contains sufficient oxygen to react with other species without oxidising the fibres enough to damage them during cool down.

68. A method according to claim 50 including directing a flow of gas to cool one or both of the electrodes and/or the substrate.

69. (canceled)

70. A method according to claim 50 wherein the electrodes and the substrate have a carbon purity in excess of 95%.

71.-73. (canceled)
